(19) United States
(12) Patent Application Publication
(10) Pub. No.: US 2026/0227627 A1
(43) Pub. Date: Aug. 6, 2026

(54) POSE ESTIMATION IN MOBILE COMPUTING SYSTEMS

(71) Applicant: QUALCOMM Incorporated, San Diego, CA (US)

(72) Inventors: Vinod Kumar SAINI, Bengaluru (IN); Srujan Babu NANDIPATI, Bangalore (IN); Pushkar GORUR SHESHAGIRI, Bengaluru (IN); Ajit Deepak GUPTE, Bangalore (IN); Gerhard REITMAYR, Del Mar, CA (US); Abhijeet BISAIN, San Diego, CA (US)

(21) Appl. No.: 19/046,420

(22) Filed: Feb. 5, 2025

(51) Int. Cl. G02B 27/00; G02B 27/01

(52) U.S. Cl. CPC G02B 27/0093; G02B 27/017; G06F 3/012; G06F 3/0346

(57) ABSTRACT

Systems and techniques are described herein for determining orientation information. For instance, a method for determining orientation information is provided. The method may include determining a pose of a head-mounted device (HMD) according to a six-degrees-of-freedom (6DoF) pose-determination mode of operation; determining that a pose constraint is satisfied based on the determined pose; and responsive to determining that the pose constraint is satisfied, determining an orientation of the HMD according to a three-degrees-of-freedom (3DoF) orientation-determination mode of operation, wherein the 3DoF orientation-determination mode of operation includes processing inertial-measurement unit (IMU) data to determine the orientation.

### TECHNICAL FIELD

The present disclosure generally relates to determining orientation information. For example, aspects of the present disclosure include systems and techniques for determining orientation information.

### BACKGROUND

Extended reality (XR) technologies can be used to present virtual content to users, and/or can combine real environments from the physical world and virtual environments to provide users with XR experiences. The term XR can encompass virtual reality (VR), augmented reality (AR), mixed reality (MR), and the like. XR systems can allow users to experience XR environments by overlaying virtual content onto a user's view of a real-world environment.

For example, an XR head-mounted device (HMD) may include a display that allows a user to view the user's real-world environment through a display of the HMD (e.g., a transparent display). The XR HMD may display virtual content at the display in the user's field of view overlaying the user's view of their real-world environment. Such an implementation may be referred to as “see-through” XR. As another example, an XR HMD may include a scene-facing camera that may capture images of the user's real-world environment. The XR HMD may modify or augment the images (e.g., adding virtual content) and display the modified images to the user. Such an implementation may be referred to as “pass through” XR or as “video see through (VST).” The user can generally change their view of the environment interactively, for example by tilting or moving the XR HMD.

Extended-reality systems may track a pose (e.g., orientation and position) of a display of the XR system. Tracking the pose of the display may allow the XR system to display virtual content relative to the real world (e.g., to anchor virtual content to points in the real world). For example, tracking the pose of the display may allow the XR system to display virtual content within a field of view of a user such that as the user moves and/or reorients the display, the virtual content remains in the same position in the user's field of view of the real world.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for determining orientation information. According to at least one example, a method is provided for determining orientation information. The method includes: determining a pose of a head-mounted device (HMD) according to a six-degrees-of-freedom (6DoF) pose-determination mode of operation; determining that a pose constraint is satisfied based on the determined pose; and responsive to determining that the pose constraint is satisfied, determining an orientation of the HMD according to a three-degrees-of-freedom (3DoF) orientation-determination mode of operation, wherein the 3DoF orientation-determination mode of operation includes processing inertial-measurement unit (IMU) data to determine the orientation.

In another example, an apparatus for determining orientation information is provided that includes at least one memory and at least one processor (e.g., configured in circuitry) coupled to the at least one memory. The at least one processor configured to: determine a pose of a head-mounted device (HMD) according to a six-degrees-of-freedom (6DoF) pose-determination mode of operation; determine that a pose constraint is satisfied based on the determined pose; and responsive to determining that the pose constraint is satisfied, determine an orientation of the HMD according to a three-degrees-of-freedom (3DoF) orientation-determination mode of operation, wherein the 3DoF orientation-determination mode of operation includes processing inertial-measurement unit (IMU) data to determine the orientation.

In another example, a non-transitory computer-readable medium is provided that has stored thereon instructions that, when executed by one or more processors, cause the one or more processors to: determine a pose of a head-mounted device (HMD) according to a six-degrees-of-freedom (6DoF) pose-determination mode of operation; determine that a pose constraint is satisfied based on the determined pose; and responsive to determining that the pose constraint is satisfied, determine an orientation of the HMD according to a three-degrees-of-freedom (3DoF) orientation-determination mode of operation, wherein the 3DoF orientation-determination mode of operation includes processing inertial-measurement unit (IMU) data to determine the orientation.

In another example, an apparatus for determining orientation information is provided. The apparatus includes: means for determining a pose of a head-mounted device (HMD) according to a six-degrees-of-freedom (6DoF) pose-determination mode of operation; means for determining that a pose constraint is satisfied based on the determined pose; and means for responsive to determining that the pose constraint is satisfied, determining an orientation of the HMD according to a three-degrees-of-freedom (3DoF) orientation-determination mode of operation, wherein the 3DoF orientation-determination mode of operation includes processing inertial-measurement unit (IMU) data to determine the orientation.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example extended-reality (XR) system, according to aspects of the disclosure;

FIG. 2 is a diagram illustrating another example extended reality (XR) system, according to aspects of the disclosure;

FIG. 3 is a block diagram illustrating an architecture of an example extended reality (XR) system, in accordance with some aspects of the disclosure;

FIG. 4 is a block diagram illustrating an architecture of a simultaneous localization and mapping (SLAM) system, according to various aspects of the present disclosure;

FIG. 5 is a block diagram illustrating an example system for determine orientation information, according to various aspects of the present disclosure;

FIG. 6 includes an illustration of an HMD and two relevant reference coordinate systems, according to various aspects of the present disclosure;

FIG. 7 includes an illustration of two relevant reference coordinate systems, according to various aspects of the present disclosure;

FIG. 8 is an illustration representing a user using an HMD to scan their face to determine R_{gn} and T_{gn}, according to various aspects of the present disclosure;

FIG. 9 is a flow diagram illustrating an example process for orientation information, in accordance with aspects of the present disclosure;

FIG. 10 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs) (which may also be referred to as a head-mounted devices), XR glasses (e.g., AR glasses, MR glasses, etc.) (also referred to as smart or network-connected glasses), among others. In some cases, XR glasses are an example of an HMD. In some cases, an XR system can track parts of the user (e.g., a hand and/or fingertips of a user) to allow the user to interact with items of virtual content.

XR systems can include virtual reality (VR) systems facilitating interactions with VR environments, augmented reality (AR) systems facilitating interactions with AR environments, mixed reality (MR) systems facilitating interactions with MR environments, and/or other XR systems.

For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects, devices, and/or points in the physical world. For example, an XR system can use tracking information to calculate the relative pose of devices, objects, and/or points of the real-world environment in order to match the relative position and movement of the devices, objects, and/or points of the real-world environment. In some examples, the XR system can use the pose and movement of one or more devices, objects, and/or points of the real-world environment to render content relative to the real-world environment in a convincing manner. The relative pose information can be used to match virtual content with the user's perceived motion and the spatio-temporal state of the devices, objects, and/or points of the real-world environment. Matching virtual content to devices, objects, and points of the real-world environment may be referred to as “anchoring.” For example, a virtual object may be anchored to a device, object, or point of the real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

A virtual representation of a user may be used to represent the user in a virtual environment. A virtual representation of a user is also referred to herein as an avatar. An avatar representing a user may mimic an appearance, movement, mannerisms, and/or other features of the user. In some examples, the user may desire that the avatar representing the person in the virtual environment appear as a digital twin of the user. In any virtual environment, it is important for an XR system to efficiently generate high-quality avatars (e.g., realistically representing the appearance, movement, etc. of the person) in a low-latency manner. It can also be important for the XR system to render audio in an effective manner to enhance the XR experience.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

As mentioned above, XR systems may track a pose (e.g., orientation and position) of a display of the XR system. Tracking the pose of the display may allow the XR system to display virtual content relative to the real world (e.g., to anchor virtual content to points in the real world). For example, tracking the pose of the display may allow the XR system to display virtual content within a field of view of a user such that as the user moves and/or reorients the display, the virtual content remains in the same position in the user's field of view of the real world.

In some cases, a display of an XR system (e.g., a head-mounted display (HMD), AR glasses, etc.) may include one or more inertial measurement units (IMUs) and may use measurements from the IMUs (e.g., IMU data) to track a pose of the display. For example, the XR system may assume an initial position of the display and track a position and/or orientation of the display based on acceleration measured by the IMUs. IMUs may include accelerometers, magnetometers, and/or gyroscopes (also referred to as gyroscopic sensors).

Additionally or alternatively, some XR systems may use a computational-geometry technique (e.g., a visual-odometry technique, a visual simultaneous localization and mapping (VSLAM), which may also be referred to as simultaneous localization and mapping (SLAM)) or other image-based techniques to track a pose of a display of such XR systems. In VSLAM, a device can capture images of an environment and keep track of the device's pose within the environment based on tracking where objects in the environment appear in the images, for example, as the device moves and/or reorients relative to the objects.

Degrees of freedom (DoF) refer to the number of basic ways a rigid object can move in three-dimensional (3D) space. In the context of systems that track movement through an environment, such as XR systems, degrees of freedom can refer to which of six degrees of freedom the system is capable of tracking. For example, 3DoF systems generally track the three rotational DoF—pitch, yaw, and roll. A 3DoF headset, for instance, can track the user of the headset turning their head left or right, tilting their head up or down, and/or tilting their head to the left or right. In some aspects, a 3DoF system may use IMU data from an IMU to track an orientation of a display.

6DoF systems can track the three rotational DoF as well as three translational DoF. For example, a 6DoF headset can track the user moving forward, backward, laterally, and/or vertically in addition to tracking the three rotational DoF. In some aspects, a 6DoF system may use image data from a camera (according to a computational-geometry technique) to determine a pose (e.g., orientation and position) of a display.

In the present disclosure, the term “pose” may refer to a position and orientation. Poses may be determined according to six degrees of freedom including three translational degrees of freedom (e.g., x, y, and z dimensions) and three rotational degrees of freedom (e.g., roll, pitch, and yaw). In the present disclosure, the term “orientation” may refer to orientation, for example, according to three rotational degrees of freedom (e.g., roll, pitch, and yaw).

There are use cases (e.g., related to multi-media consumption) that can be addressed using 3DoF solutions in XR. For instance, a user may be stationary (e.g., seated) and may watch virtual content using an XR device (e.g., the user may watch a movie which may, or may not, include 3D virtual content using an XR device). The XR device may anchor the virtual content to point in an environment of the user (e.g., a wall, a desk, etc.). As another example, a user may be stationary and may interact with a virtual desktop or play a game using an XR device. The XR device may anchor the virtual desktop or content of the game to points in the environment. As yet another example, the virtual content may be anchored to a point in the environment that is so distant that translation of the XR device do not appreciably change the view of the virtual content. For example, the virtual content may include a mountain on a horizon. In such cases, while the user's position remains constant, a 3DoF (orientation and not position) solution may be sufficient to anchor the virtual content to the environment and render the virtual content.

Systems and techniques are described for determining orientation data. The systems and techniques may determine a 6DoF pose (e.g., orientation and position) of an HMD according to a 6DoF pose-determination mode of operation. The systems and techniques may determine that a pose constraint is satisfied. For instances, the systems and techniques may determine a camera translation and compare the camera translation with an expected range of motion of a neck of the user to decide whether neck constraints are satisfied. Additionally or alternatively, the systems and techniques may determine whether:

$${( {R}_{n g} {V}_{g c} )}^{T} ( {T}_{n g} + {R}_{n g} {T}_{g c} ) + {( {T}_{n g} + {R}_{n g} {T}_{g c} )}^{T} ( {R}_{n g} {V}_{g c} ) = 0$$

where R_{ng} represents a rotation (e.g., a rotation matrix) between a reference coordinate system and a coordinate system of a neck of a user; V_{gc} represents a velocity of a coordinate system of the HMD relative to the reference coordinate system; T_{ng} represents a translation (e.g., translation matrix) between the reference coordinate system and the coordinate system of the neck of the user; and T_{gc} represents a translation between the coordinate system of the HMD and the reference coordinate system.

As another example of determining whether the pose constraint is satisfied, the systems and techniques may determine whether the HMD's motion is around the neck. If the motion is around the neck, translation components of the HMD's pose will lie on sphere that is centered on the neck. To determine whether the HMD's motion is around the neck the systems and techniques may take the most-recent few seconds (e.g., 10-20 seconds) of translation estimates determined based on the 6DoF pose of the HMD. The systems and techniques may fit the translation estimates to a sphere centered on the neck of the user. Further, the systems and techniques may determine whether the residuals from the sphere fit are within a threshold. The residuals being within the threshold indicates that the positions/translations lie on sphere. The systems and techniques may check if the radius of the sphere fit is within the range of neck to display. The residuals being within the threshold, and radius being within the range means that motion is around the neck.

Responsive to determining that the pose constraint is satisfied, the systems and techniques may switch from the 6DoF pose-determination mode of operation (e.g., 6DoF operation) to an orientation-determination mode of operation (which may be referred to as a 3DoF orientation-determination mode of operation). In the orientation-determination mode of operation, the systems and techniques may determine a 3DoF orientation (including orientation and not position) of the HMD (e.g., based on IMU data from an IMU of the HMD).

The systems and techniques may conserve computational resources (such as computational time and power) in the orientation-determination mode of operation as compared to the 6DoF pose-determination mode of operation. For example, by determining the orientation of the HMD and not determining the position of the HMD using a computational-geometry technique (e.g., not using image data in a simultaneous localization and mapping (SLAM) technique), the systems and techniques may conserver computational resources.

Various aspects of the application will be described with respect to the figures below.

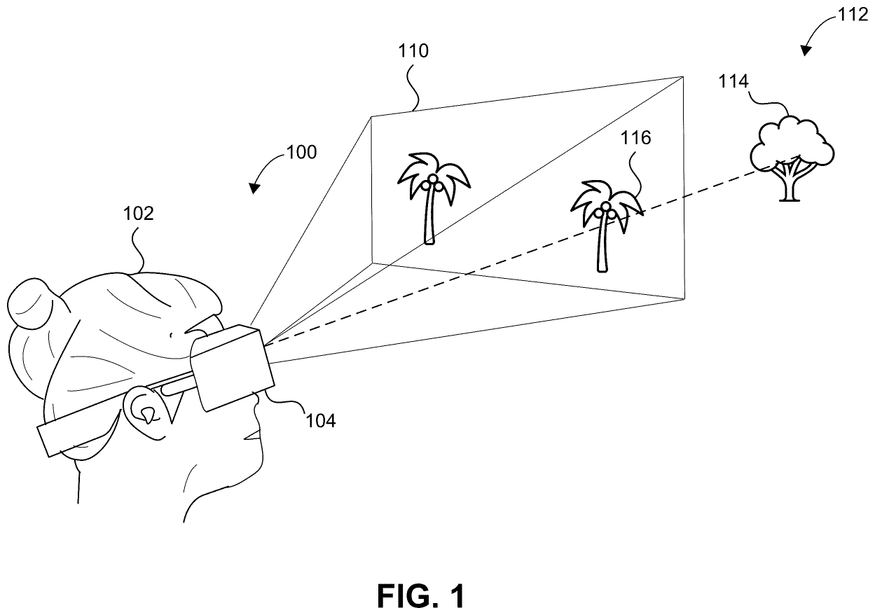

FIG. 1 is a diagram illustrating an example extended-reality (XR) system 100, according to various aspects of the disclosure. As shown, XR system 100 includes an XR device 104. XR device 104 may implement, as examples, image-capture, object-detection, object-tracking, gaze-tracking, view-tracking, localization (e.g., determining a location of XR device 104), pose-tracking (e.g., tracking a pose of XR device 104), content-generation, content-rendering, computational, communicational, and/or display aspects of extended reality, including virtual reality (VR), augmented reality (AR), and/or mixed reality (MR).

For example, XR device 104 may include one or more scene-facing cameras that may capture images of a scene 112 in which a user 102 uses XR device 104. XR device 104 may detect objects (e.g., object 114) in scene 112 based on the images of scene 112. In some aspects, XR device 104 may include one or more user-facing cameras that may capture images of eyes of user 102. XR device 104 may determine a gaze of user 102 based on the images of user 102. In some aspects, XR device 104 may determine an object of interest (e.g., object 114) in scene 112 (e.g., based on the gaze of user 102, based on object recognition, and/or based on a received indication regarding object 114). XR device 104 may obtain and/or render XR content 116 (e.g., text, images, and/or video) for display at XR device 104. XR device 104 may display XR content 116 to user 102 (e.g., within a field of view 110 of user 102). In some aspects, XR content 116 may be based on an object in scene 112. For example, XR content 116 may be an altered version of object 114. As another example, XR content 116 may appear to interact with object 114. For example, object 114 may be a tree and XR content 116 may include a monkey climbing the tree.

In some aspects, XR device 104 may display XR content 116 in relation to the view of user 102 of the object of interest. For example, XR device 104 may overlay XR content 116 onto object 114 in field of view 110. In any case, XR device 104 may overlay XR content 116 (whether related to object 114 or not) onto the view of user 102 of scene 112. XR device 104 may anchor XR content 116 to object 114, for example, such that as user 102 moves their head (e.g., changing field of view 110), XR content 116 remains in the line of sight between the eyes of user 102 and object 114. To do this, XR device 104 may track a pose of XR device 104 (e.g., based on movement data from one or more inertial measurement units (IMUs) of XR device 104.

In a “see-through” configuration, XR device 104 may include a transparent surface (e.g., optical glass) such that XR content 116 may be displayed on (e.g., by being projected onto) the transparent surface to overlay the view of user 102 of scene 112 as viewed through the transparent surface. In a “pass-through” configuration or a “video see-through” (VST) configuration, XR device 104 may include a scene-facing camera that may capture images of scene 112. XR device 104 may display images or video of scene 112, as captured by the scene-facing camera, and XR content 116 overlaid on the images or video of scene 112.

In various examples, XR device 104 may be, or may include, a head-mounted device (HMD), a virtual reality headset, and/or smart glasses. XR device 104 may include one or more cameras, including scene-facing cameras and/or user-facing cameras, a GPU, one or more sensors (e.g., such as one or more inertial measurement units (IMUs), image sensors, and/or microphones), one or more communication units (e.g., wireless communication units), and/or one or more output devices (e.g., such as speakers, headphones, displays, and/or smart glass). In other examples, XR device 104 may include a handheld device with a display, such as a smartphone or tablet.

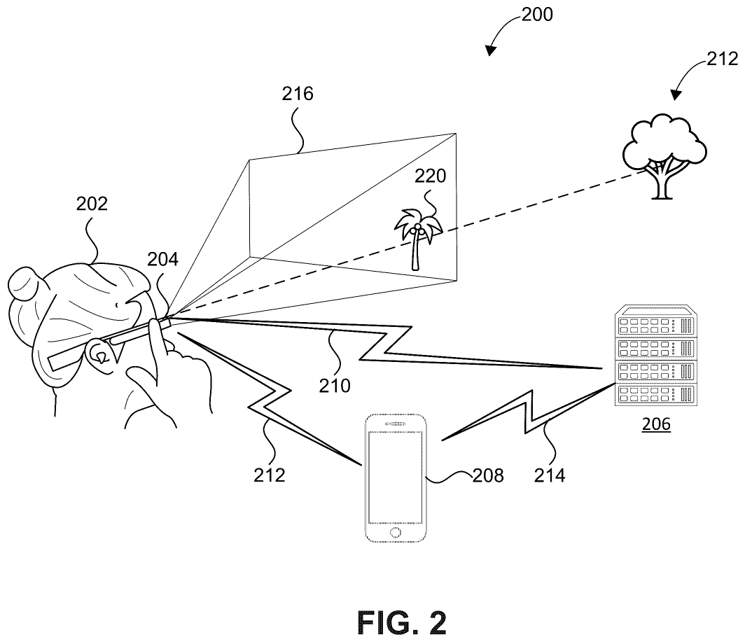

FIG. 2 is a diagram illustrating an example extended reality (XR) system 200, according to aspects of the disclosure. In some aspects, an XR system may be, or may include, two or more devices. The two or more devices of XR system 200 may perform the operations described with regard to XR system 100 of FIG. 1.

For example, XR system 200 includes a display device 204 and a processing device 206. In some aspects, display device 204 and processing device 206 may implement a communication link 210 between display device 204 and processing device 206. Communication link 210 may be a wireless connection according to any suitable wireless protocol, such as, a broadband-cellular-network protocol, for example, a fifth generation (5G) wireless cellular protocol.

In some aspects, XR system 200 may include a companion device 208. Display device 204 and companion device 208 and may implement a communication link 212 between display device 204 and companion device 208 and companion device 208 and processing device 206 may implement a communication link 214 between companion device 208 and processing device 206. Communication link 212 may be a wireless connection according to any suitable wireless protocol, such as, for example, Institute of Electrical and Electronics Engineers (IEEE) 802.11 (Wi-Fi), IEEE 802.15, or Bluetooth®. Communication link 214 may be a wireless connection according to any suitable wireless protocol, such as, a broadband-cellular-network protocol, for example, a fifth generation (5G) wireless cellular protocol.

Display device 204, processing device 206, and/or companion device 208 may collectively implement as examples, image-capture, object-detection, object-tracking, gaze-tracking, view-tracking, localization, pose-tracking, content-generation, content-rendering, computational, communicational, and/or display aspects of XR. For example, display device 204 may implement image-capture, gaze-tracking, view-tracking, localization, pose-tracking, communicational, and/or display aspects of XR. Processing device 206 may implement object-detection, object-tracking, localization, content-generation, content-rendering, computational, and/or communicational, aspects of XR. Additionally or alternatively, companion device 208 may implement at least a portion of one or more of localization, pose-tracking, communicational, object-detection, object-tracking, localization, content-generation, content-rendering, and/or computational aspects of XR.

For example, display device 204 may capture and/or generate data, such as image data (e.g., from user-facing cameras and/or scene-facing cameras) and/or motion data (from an inertial measurement unit (IMU)). Display device 204 may provide the data to processing device 206, for example, through communication link 210 or through communication link 212, companion device 208, and communication link 214.

Processing device 206 may process the data and/or other data (e.g., data received from another source or data stored at processing device 206). For example, processing device 206 may detect, recognize, and/or track objects in scene 218 based on the images of scene 218. Further, processing device 206 may generate (or obtain) XR content 220 to be rendered for display at display device 204. Processing device 206 may render XR content 220 to be appropriate for display at display device 204 (e.g., based on a pose of display device 204). Processing device 206 may provide rendered XR content 220 to display device 204 through communication link 210 (or communication link 214, companion device 208, and communication link 212) and display device 204 may display XR content 220 in field of view 216 of user 202.

In various examples, display device 204 may be, or may include, a head-mounted display (HMD), a virtual reality headset, and/or smart glasses. Display device 204 may include one or more cameras, including scene-facing cameras and/or user-facing cameras, a GPU, one or more sensors (e.g., such as one or more inertial measurement units (IMUs), image sensors, and/or microphones), and/or one or more output devices (e.g., such as speakers, headphones, displays, and/or smart glass). In other examples, display device 204 may include a handheld device with a display, such as a smartphone or tablet.

Processing device 206 may be, or may include, for example, a server computer (e.g., an edge or cloud-based server, a personal computer acting as a server device, or a mobile device acting as a server device). Processing device 206 may be configured to store virtual content and/or perform operations related to rendering the virtual content as image data suitable for providing to display device 204 for display. Companion device 208 may be, or may include, a smartphone, laptop, tablet computer, personal computer, gaming system, any other computing device and/or a combination thereof.

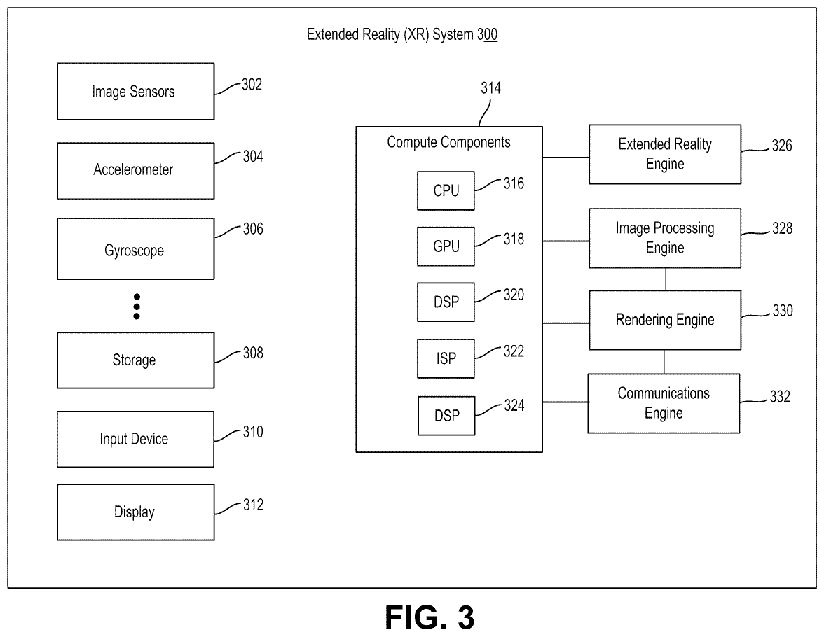

FIG. 3 is a diagram illustrating an architecture of an example extended reality (XR) system 300, in accordance with some aspects of the disclosure. XR system 300 may execute XR applications and implement XR operations. XR system 300 may be an example of, or be included in, any of XR device 104 of FIG. 1, display device 204 and/or companion device 208 of FIG. 2, and/or processing device 206 of FIG. 2.

In this illustrative example, XR system 300 includes one or more image sensors 302, an accelerometer 304, a gyroscope 306, storage 308, an input device 310, a display 312, Compute components 314, an XR engine 326, an image processing engine 328, a rendering engine 330, and a communications engine 332. It should be noted that the components 302-332 shown in FIG. 3 are non-limiting examples provided for illustrative and explanation purposes, and other examples may include more, fewer, or different components than those shown in FIG. 3. For example, in some cases, XR system 300 may include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 3. While various components of XR system 300, such as image sensor 302, may be referenced in the singular form herein, it should be understood that XR system 300 may include multiple of any component discussed herein (e.g., multiple image sensors 302).

Display 312 may be, or may include, a glass, a screen, a lens, a projector, and/or other display mechanism that allows a user to see the real-world environment and also allows XR content to be overlaid, overlapped, blended with, or otherwise displayed thereon.

XR system 300 may include, or may be in communication with, (wired or wirelessly) an input device 310. Input device 310 may include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 302 may capture images that may be processed for interpreting gesture commands.

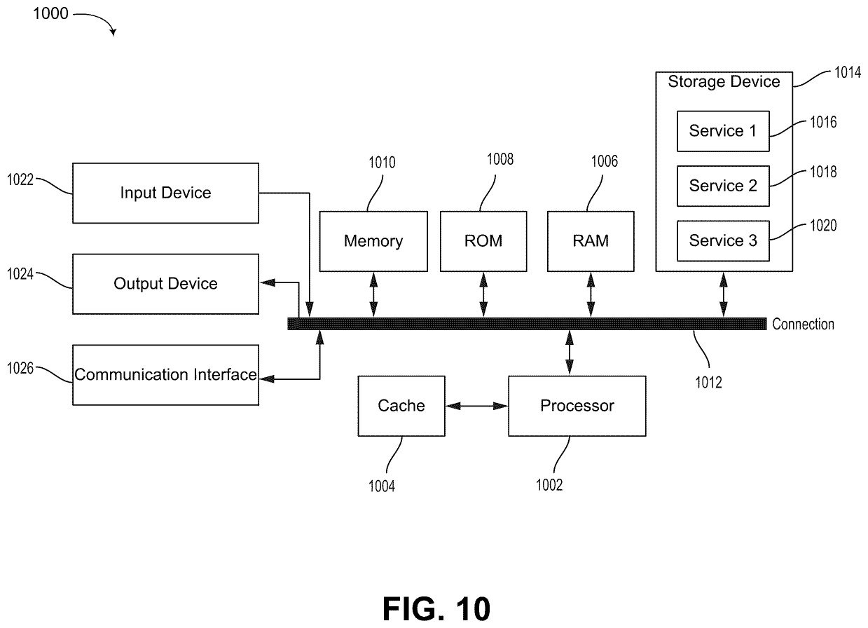

XR system 300 may also communicate with one or more other electronic devices (wired or wirelessly). For example, communications engine 332 may be configured to manage connections and communicate with one or more electronic devices. In some cases, communications engine 332 may correspond to communication interface 1026 of FIG. 10.

In some implementations, image sensors 302, accelerometer 304, gyroscope 306, storage 308, display 312, compute components 314, XR engine 326, image processing engine 328, and rendering engine 330 may be part of the same computing device. For example, in some cases, image sensors 302, accelerometer 304, gyroscope 306, storage 308, display 312, compute components 314, XR engine 326, image processing engine 328, and rendering engine 330 may be integrated into an HMD, extended reality glasses, smartphone, laptop, tablet computer, gaming system, and/or any other computing device. However, in some implementations, image sensors 302, accelerometer 304, gyroscope 306, storage 308, display 312, compute components 314, XR engine 326, image processing engine 328, and rendering engine 330 may be part of two or more separate computing devices. For instance, in some cases, some of the components 302-332 may be part of, or implemented by, one computing device and the remaining components may be part of, or implemented by, one or more other computing devices. For example, such as in a split perception XR system, XR system 300 may include a first device (e.g., an HMD), including display 312, image sensor 302, accelerometer 304, gyroscope 306, and/or one or more compute components 314. XR system 300 may also include a second device including additional compute components 314 (e.g., implementing XR engine 326, image processing engine 328, rendering engine 330, and/or communications engine 332). In such an example, the second device may generate virtual content based on information or data (e.g., images, sensor data such as measurements from accelerometer 304 and gyroscope 306) and may provide the virtual content to the first device for display at the first device. The second device may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 308 may be any storage device(s) for storing data. Moreover, storage 308 may store data from any of the components of XR system 300. For example, storage 308 may store data from image sensor 302 (e.g., image or video data), data from accelerometer 304 (e.g., measurements), data from gyroscope 306 (e.g., measurements), data from compute components 314 (e.g., processing parameters, preferences, virtual content, rendering content, scene maps, tracking and localization data, object detection data, privacy data, XR application data, face recognition data, occlusion data, etc.), data from XR engine 326, data from image processing engine 328, and/or data from rendering engine 330 (e.g., output frames). In some examples, storage 308 may include a buffer for storing frames for processing by compute components 314.

Compute components 314 may be, or may include, a central processing unit (CPU) 316, a graphics processing unit (GPU) 318, a digital signal processor (DSP) 320, an image signal processor (ISP) 322, a neural processing unit (NPU) 324, which may implement one or more trained neural networks, and/or other processors. Compute components 314 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 314 may implement (e.g., control, operate, etc.) XR engine 326, image processing engine 328, and rendering engine 330. In other examples, compute components 314 may also implement one or more other processing engines.

Image sensor 302 may include any image and/or video sensors or capturing devices. In some examples, image sensor 302 may be part of a multiple-camera assembly, such as a dual-camera assembly. Image sensor 302 may capture image and/or video content (e.g., raw image and/or video data), which may then be processed by compute components 314, XR engine 326, image processing engine 328, and/or rendering engine 330 as described herein.

In some examples, image sensor 302 may capture image data and may generate images (also referred to as frames) based on the image data and/or may provide the image data or frames to XR engine 326, image processing engine 328, and/or rendering engine 330 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 302 (and/or other camera of XR system 300) may be configured to also capture depth information. For example, in some implementations, image sensor 302 (and/or other camera) may include an RGB-depth (RGB-D) camera. In some cases, XR system 300 may include one or more depth sensors (not shown) that are separate from image sensor 302 (and/or other camera) and that may capture depth information. For instance, such a depth sensor may obtain depth information independently from image sensor 302. In some examples, a depth sensor may be physically installed in the same general location or position as image sensor 302 but may operate at a different frequency or frame rate from image sensor 302. In some examples, a depth sensor may take the form of a light source that may project a structured or textured light pattern, which may include one or more narrow bands of light, onto one or more objects in a scene. Depth information may then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 300 may also include other sensors in its one or more sensors. The one or more sensors may include one or more accelerometers (e.g., accelerometer 304), one or more gyroscopes (e.g., gyroscope 306), and/or other sensors. The one or more sensors may provide velocity, orientation, and/or other position-related information to compute components 314. For example, accelerometer 304 may detect acceleration by XR system 300 and may generate acceleration measurements based on the detected acceleration. In some cases, accelerometer 304 may provide one or more translational vectors (e.g., up/down, left/right, forward/back) that may be used for determining a position or pose of XR system 300. Gyroscope 306 may detect and measure the orientation and angular velocity of XR system 300. For example, gyroscope 306 may be used to measure the pitch, roll, and yaw of XR system 300. In some cases, gyroscope 306 may provide one or more rotational vectors (e.g., pitch, yaw, roll). In some examples, image sensor 302 and/or XR engine 326 may use measurements obtained by accelerometer 304 (e.g., one or more translational vectors) and/or gyroscope 306 (e.g., one or more rotational vectors) to calculate the pose of XR system 300. As previously noted, in other examples, XR system 300 may also include other sensors, such as, a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors may include at least one IMU. An IMU is an electronic device that measures the specific force, angular rate, and/or the orientation of XR system 300, using a combination of one or more accelerometers, one or more gyroscopes, and/or one or more magnetometers. For example, an IMU of XR system 300 may include accelerometer 304, gyroscope 306, and/or a magnetometer. In some examples, the one or more sensors may output measured information associated with the capture of an image captured by image sensor 302 (and/or other camera of XR system 300) and/or depth information obtained using one or more depth sensors of XR system 300.

The output of one or more sensors (e.g., accelerometer 304, gyroscope 306, and/or other sensors) can be used by XR engine 326 to determine a pose of XR system 300 (also referred to as the head pose) and/or the pose of image sensor 302 (or other camera of XR system 300). In some cases, the pose of XR system 300 and the pose of image sensor 302 (or other camera) can be the same. The pose of image sensor 302 refers to the position and orientation of image sensor 302 relative to a frame of reference (e.g., with respect to a field of view 110 of FIG. 1). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g., roll, pitch, and yaw relative to the same frame of reference). In some implementations, the camera pose can be determined for 3-Degrees of Freedom (3DoF), which refers to the three angular components (e.g., roll, pitch, and yaw).

In some cases, a device tracker (not shown) can use the measurements from the one or more sensors and image data from image sensor 302 to track a pose (e.g., a 6DoF pose) of XR system 300. For example, the device tracker can fuse visual data (e.g., using a visual tracking solution) from the image data with inertial data from the measurements to determine a position and motion of XR system 300 relative to the physical world (e.g., the scene) and a map of the physical world. As described below, in some examples, when tracking the pose of XR system 300, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 300 within the scene and the 3D map of the scene, etc. The 3D map can provide a digital representation of a scene in the real/physical world. In some examples, the 3D map can anchor position-based objects and/or content to real-world coordinates and/or objects. XR system 300 can use a mapped scene (e.g., a scene in the physical world represented by, and/or associated with, a 3D map) to merge the physical and virtual worlds and/or merge virtual content or objects with the physical environment.

In some aspects, the pose of image sensor 302 and/or XR system 300 as a whole can be determined and/or tracked by compute components 314 using a visual tracking solution based on images captured by image sensor 302 (and/or other camera of XR system 300). For instance, in some examples, compute components 314 can perform tracking using computer vision-based tracking, model-based tracking, and/or simultaneous localization and mapping (SLAM) techniques. For instance, compute components 314 can perform SLAM or can be in communication (wired or wireless) with a SLAM system (not shown). SLAM refers to a class of techniques where a map of an environment (e.g., a map of an environment being modeled by XR system 300) is created while simultaneously tracking the pose of a camera (e.g., image sensor 302) and/or XR system 300 relative to that map. The map can be referred to as a SLAM map and can be three-dimensional (3D). The SLAM techniques can be performed using color or grayscale image data captured by image sensor 302 (and/or other camera of XR system 300) and can be used to generate estimates of 6DoF pose measurements of image sensor 302 and/or XR system 300. Such a SLAM technique configured to perform 6DoF tracking can be referred to as 6DoF SLAM. In some cases, the output of the one or more sensors (e.g., accelerometer 304, gyroscope 306, and/or other sensors) can be used to estimate, correct, and/or otherwise adjust the estimated pose.

In some cases, the 6DoF SLAM (e.g., 6DoF tracking) can associate features observed from certain input images from the image sensor 302 (and/or other camera) to the SLAM map. For example, 6DoF SLAM can use feature point associations from an input image to determine the pose (position and orientation) of the image sensor 302 and/or XR system 300 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 302 and/or the XR system 300 can be determined by projecting features from the 3D SLAM map into an image or video frame and updating the camera pose from verified 2D-3D correspondences.

In one illustrative example, the compute components 314 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 314 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 300 can also track the hand and/or fingers of the user to allow the user to interact with and/or control virtual content in a virtual environment. For example, the XR system 300 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

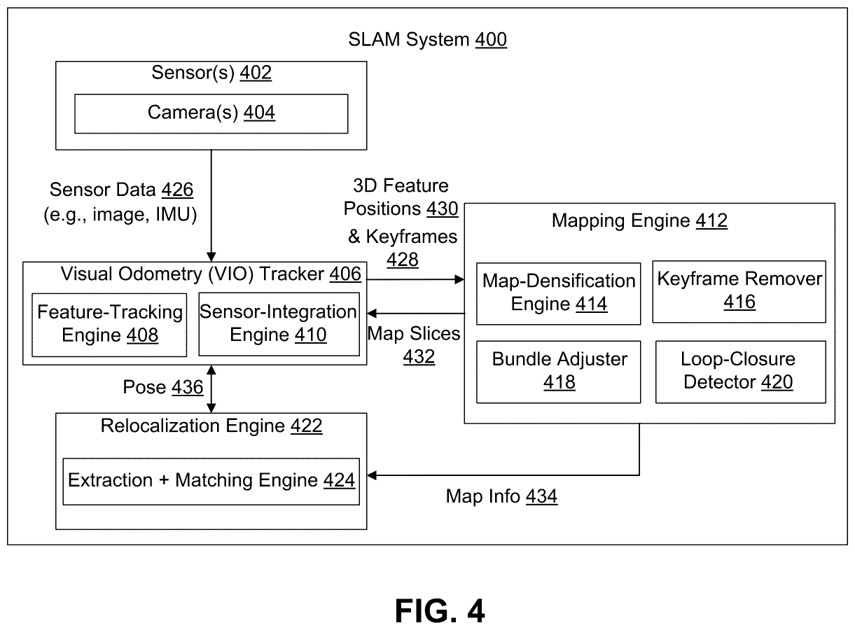

FIG. 4 is a block diagram illustrating an architecture of a simultaneous localization and mapping (SLAM) system 400, according to various aspects of the present disclosure. In some aspects, SLAM system 400 can be, or can include, a wireless communication device, a mobile device or handset (e.g., a mobile telephone or so-called “smart phone” or other mobile device), a wearable device, a personal computer, a laptop computer, a server computer, a portable video game console, a portable media player, a camera device, a manned or unmanned ground vehicle, a manned or unmanned aerial vehicle, a manned or unmanned aquatic vehicle, a manned or unmanned underwater vehicle, a manned or unmanned vehicle, an autonomous vehicle, a vehicle, a computing system of a vehicle, a robot, another device, or any combination thereof.

SLAM system 400 of FIG. 4 includes, or is coupled to, one or more sensor(s) 402. Sensor(s) 402 can include one or more camera(s) 404. Each of camera(s) 404 may be responsive to light from a particular spectrum of light. The spectrum of light may be a subset of the electromagnetic (EM) spectrum. For example, each of camera(s) 404 may be a visible light (VL) camera responsive to a VL spectrum, an infrared (IR) camera responsive to an IR spectrum, an ultraviolet (UV) camera responsive to a UV spectrum, a camera responsive to light from another spectrum of light from another portion of the electromagnetic spectrum, or a some combination thereof.

Sensor(s) 402 can include one or more other types of sensors other than camera(s) 404, such as one or more of each of: accelerometers, gyroscopes, magnetometers, inertial measurement units (IMUs), (which may include one or more accelerometers, one or more gyroscopes, and/or one or more magnetometers) altimeters, barometers, thermometers, radio detection and ranging (RADAR) sensors, light detection and ranging (LIDAR) sensors, sound navigation and ranging (SONAR) sensors, sound detection and ranging (SODAR) sensors, global navigation satellite system (GNSS) receivers, global positioning system (GPS) receivers, BeiDou navigation satellite system (BDS) receivers, Galileo receivers, Globalnaya Navigazionnaya Sputnikovaya Sistema (GLONASS) receivers, Navigation Indian Constellation (NavIC) receivers, Quasi-Zenith Satellite System (QZSS) receivers, Wi-Fi positioning system (WPS) receivers, cellular network positioning system receivers, Bluetooth® beacon positioning receivers, short-range wireless beacon positioning receivers, personal area network (PAN) positioning receivers, wide area network (WAN) positioning receivers, wireless local area network (WLAN) positioning receivers, other types of positioning receivers, other types of sensors discussed herein, or combinations thereof.

SLAM system 400 includes a visual-inertial odometry (VIO) tracker 406. The term visual-inertial odometry may also be referred to herein as visual odometry. VIO tracker 406 receives sensor data 426 from sensor(s) 402. For instance, sensor data 426 can include one or more images captured by camera(s) 404. Sensor data 426 can include other types of sensor data from sensor(s) 402, such as data from any of the types of sensor(s) 402 listed herein. For instance, sensor data 426 can include inertial measurement unit (IMU) data from one or more IMUs of sensor(s) 402.

Upon receipt of sensor data 426 from sensor(s) 402, VIO tracker 406 performs feature detection, extraction, and/or tracking using a feature-tracking engine 408 of VIO tracker 406. For instance, where sensor data 426 includes one or more images captured by camera(s) 404 of SLAM system 400, VIO tracker 406 can identify, detect, and/or extract features in each image. Features may include visually distinctive points in an image, such as portions of the image depicting edges and/or corners. VIO tracker 406 can receive sensor data 426 periodically and/or continually from sensor(s) 402, for instance by continuing to receive more images from camera(s) 404 as camera(s) 404 capture a video, where the images are video frames of the video. VIO tracker 406 can generate descriptors for the features. Feature descriptors can be generated at least in part by generating a description of the feature as depicted in a local image patch extracted around the feature. In some examples, a feature descriptor can describe a feature as a collection of one or more feature vectors. VIO tracker 406, in some cases with mapping engine 412 and/or relocalization engine 422, can associate the plurality of features with a map of the environment based on such feature descriptors. Feature-tracking engine 408 of VIO tracker 406 can perform feature tracking by recognizing features in each image that VIO tracker 406 already previously recognized in one or more previous images, in some cases based on identifying features with matching feature descriptors in different images. Feature-tracking engine 408 can track changes in one or more positions at which the feature is depicted in each of the different images. For example, the feature extraction engine can detect a particular corner of a room depicted in a left side of a first image captured by a first camera of camera(s) 404. Feature-tracking engine 408 can detect the same feature (e.g., the same particular corner of the same room) depicted in a right side of a second image captured by the first camera. Feature-tracking engine 408 can recognize that the features detected in the first image and the second image are two depictions of the same feature (e.g., the same particular corner of the same room), and that the feature appears in two different positions in the two images. VIO tracker 406 can determine, based on the same feature appearing on the left side of the first image and on the right side of the second image that the first camera has moved, for example if the feature (e.g., the particular corner of the room) depicts a static portion of the environment.

VIO tracker 406 can include a sensor-integration engine 410. Sensor-integration engine 410 can use sensor data from other types of sensor(s) 402 (other than camera(s) 404) to determine information that can be used by feature-tracking engine 408 when performing the feature tracking. For example, sensor-integration engine 410 can receive IMU data (e.g., which can be included as part of sensor data 426) from an IMU of sensor(s) 402. Sensor-integration engine 410 can determine, based on the IMU data in sensor data 426, that SLAM system 400 has rotated 15 degrees in a clockwise direction from acquisition or capture of a first image and capture to acquisition or capture of the second image by a first camera of camera(s) 404. Based on this determination, sensor-integration engine 410 can identify that a feature depicted at a first position in the first image is expected to appear at a second position in the second image, and that the second position is expected to be located to the left of the first position by a predetermined distance (e.g., a predetermined number of pixels, inches, centimeters, millimeters, or another distance metric). Feature-tracking engine 408 can take this expectation into consideration in tracking features between the first image and the second image.

Based on the feature tracking by feature-tracking engine 408 and/or the sensor integration by sensor-integration engine 410, VIO tracker 406 can determine a 3D feature positions 430 of a particular feature. 3D feature positions 430 can include one or more 3D feature positions and can also be referred to as 3D feature points. 3D feature positions 430 can be a set of coordinates along three different axes that are perpendicular to one another, such as an X coordinate along an X axis (e.g., in a horizontal direction), a Y coordinate along a Y axis (e.g., in a vertical direction) that is perpendicular to the X axis, and a Z coordinate along a Z axis (e.g., in a depth direction) that is perpendicular to both the X axis and the Y axis. VIO tracker 406 can also determine one or more keyframes 428 (referred to hereinafter as keyframes 428) corresponding to the particular feature. A keyframe (from one or more keyframes 428) corresponding to a particular feature may be an image in which the particular feature is clearly depicted. In some examples, a keyframe corresponding to a particular feature may be an image that reduces uncertainty in 3D feature positions 430 of the particular feature when considered by feature-tracking engine 408 and/or sensor-integration engine 410 for determination of 3D feature positions 430. In some examples, a keyframe corresponding to a particular feature also includes data associated with pose 436 of SLAM system 400 and/or camera(s) 404 during capture of the keyframe. In some examples, VIO tracker 406 can send 3D feature positions 430 and/or keyframes 428 corresponding to one or more features to mapping engine 412. In some examples, VIO tracker 406 can receive map slices 432 from mapping engine 412. VIO tracker 406 can feature information within map slices 432 for feature tracking using feature-tracking engine 408.

Based on the feature tracking by feature-tracking engine 408 and/or the sensor integration by sensor-integration engine 410, VIO tracker 406 can determine a pose 436 of SLAM system 400 and/or of camera(s) 404 during capture of each of the images in sensor data 426. Pose 436 can include a location of SLAM system 400 and/or of camera(s) 404 in 3D space, such as a set of coordinates along three different axes that are perpendicular to one another (e.g., an X coordinate, a Y coordinate, and a Z coordinate). Pose 436 can include an orientation of SLAM system 400 and/or of camera(s) 404 in 3D space, such as pitch, roll, yaw, or some combination thereof. In some examples, VIO tracker 406 can send pose 436 to relocalization engine 422. In some examples, VIO tracker 406 can receive pose 436 from relocalization engine 422.

SLAM system 400 also includes a mapping engine 412. Mapping engine 412 generates a 3D map of the environment based on 3D feature positions 430 and/or keyframes 428 received from VIO tracker 406. Mapping engine 412 can include a map-densification engine 414, a keyframe remover 416, a bundle adjuster 418, and/or a loop-closure detector 420. Map-densification engine 414 can perform map densification, in some examples, increase the quantity and/or density of 3D coordinates describing the map geometry. Keyframe remover 416 can remove keyframes, and/or in some cases add keyframes. In some examples, keyframe remover 416 can remove keyframes 428 corresponding to a region of the map that is to be updated and/or whose corresponding confidence values are low. Bundle adjuster 418 can, in some examples, refine the 3D coordinates describing the scene geometry, parameters of relative motion, and/or optical characteristics of the image sensor used to generate the frames, according to an optimality criterion involving the corresponding image projections of all points. Loop-closure detector 420 can recognize when SLAM system 400 has returned to a previously mapped region and can use such information to update a map slice and/or reduce the uncertainty in certain 3D feature points or other points in the map geometry. Mapping engine 412 can output map slices 432 to VIO tracker 406. Map slices 432 can represent 3D portions or subsets of the map. Map slices 432 can include map slices 432 that represent new, previously-unmapped areas of the map. Map slices 432 can include map slices 432 that represent updates (or modifications or revisions) to previously-mapped areas of the map. Mapping engine 412 can output map information 434 to relocalization engine 422. Map information 434 can include at least a portion of the map generated by mapping engine 412. Map information 434 can include one or more 3D points making up the geometry of the map, such as one or more 3D feature positions 430. Map information 434 can include one or more keyframes 428 corresponding to certain features and certain 3D feature positions 430.

SLAM system 400 also includes relocalization engine 422. Relocalization engine 422 can perform relocalization, for instance when VIO tracker 406 fail to recognize more than a threshold number of features in an image, and/or VIO tracker 406 loses track of pose 436 of SLAM system 400 within the map generated by mapping engine 412. Relocalization engine 422 can perform relocalization by performing extraction and matching using an extraction and matching engine 424. For instance, extraction and matching engine 424 can by extract features from an image captured by camera(s) 404 of SLAM system 400 while SLAM system 400 is at a current pose 436, and can match the extracted features to features depicted in different keyframes 428, identified by 3D feature positions 430, and/or identified in map information 434. By matching these extracted features to the previously-identified features, relocalization engine 422 can identify that pose 436 of SLAM system 400 is a pose 436 at which the previously-identified features are visible to camera(s) 404 of SLAM system 400, and is therefore similar to one or more previous poses 436 at which the previously-identified features were visible to camera(s) 404. In some cases, relocalization engine 422 can perform relocalization based on wide baseline mapping, or a distance between a current camera position and camera position at which feature was originally captured. Relocalization engine 422 can receive information for pose 436 from VIO tracker 406, for instance regarding one or more recent poses of SLAM system 400 and/or camera(s) 404 which relocalization engine 422 can base its relocalization determination on. Once relocalization engine 422 relocates SLAM system 400 and/or camera(s) 404 and thus determines pose 436, relocalization engine 422 can output pose 436 to VIO tracker 406.

In some examples, VIO tracker 406 can modify the image in sensor data 426 before performing feature detection, extraction, and/or tracking on the modified image. For example, VIO tracker 406 can rescale and/or resample the image. In some examples, rescaling and/or resampling the image can include downscaling, downsampling, subscaling, and/or subsampling the image one or more times. In some examples, VIO tracker 406 modifying the image can include converting the image from color to greyscale, or from color to black and white, for instance by desaturating color in the image, stripping out certain color channel(s), decreasing color depth in the image, replacing colors in the image, or a combination thereof. In some examples, VIO tracker 406 modifying the image can include VIO tracker 406 masking certain regions of the image. Dynamic objects can include objects that can have a changed appearance between one image and another. For example, dynamic objects can be objects that move within the environment, such as people, vehicles, or animals. A dynamic objects can be an object that have a changing appearance at different times, such as a display screen that may display different things at different times. A dynamic object can be an object that has a changing appearance based on the pose of camera(s) 404, such as a reflective surface, a prism, or a specular surface that reflects, refracts, and/or scatters light in different ways depending on the position of camera(s) 404 relative to the dynamic object. VIO tracker 406 can detect the dynamic objects using facial detection, facial recognition, facial tracking, object detection, object recognition, object tracking, or a combination thereof. VIO tracker 406 can detect the dynamic objects using one or more artificial intelligence algorithms, one or more trained machine learning models, one or more trained neural networks, or a combination thereof. VIO tracker 406 can mask one or more dynamic objects in the image by overlaying a mask over an area of the image that includes depiction(s) of the one or more dynamic objects. The mask can be an opaque color, such as black. The area can be a bounding box having a rectangular or other polygonal shape. The area can be determined on a pixel-by-pixel basis.

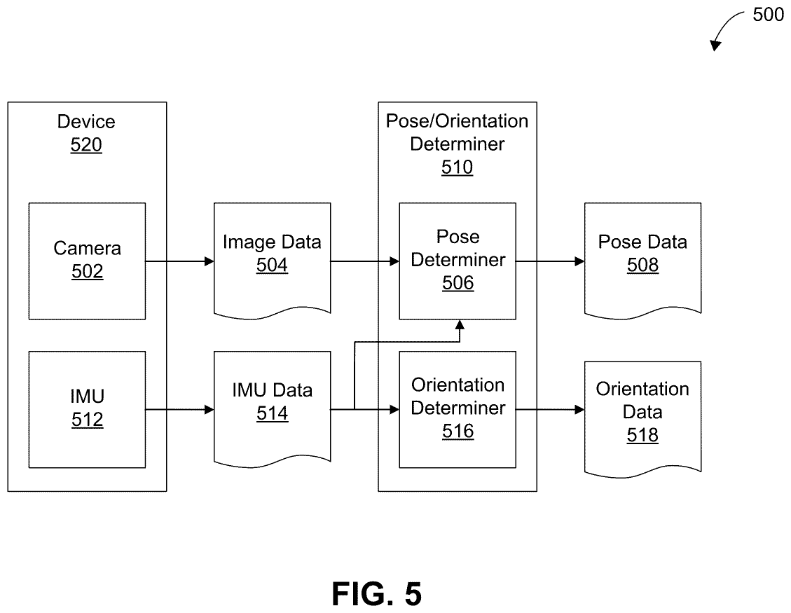

FIG. 5 is a block diagram illustrating an example system 500 for determining orientation information, according to various aspects of the present disclosure. For example, system 500 may determine orientation information (e.g., pose data 508 and/or orientation data 518) of a device 520 (e.g., an HMD) according to various aspects of the present disclosure. In some aspects, device 520 may include a processor that implements pose/orientation determiner 510. In other aspects, pose/orientation determiner 510 may be implemented by a device separate from device 520 (e.g., a companion device or server).

For example, system 500 may determine a 6DoF pose (e.g., orientation and position) of a device 520 (e.g., an HMD) according to a 6DoF pose-determination mode of operation. For example, pose/orientation determiner 510 may obtain image data 504 (e.g., from camera 502 of device 520). System 500 may use a pose determiner 506 to determine pose data 508 (e.g., indicative of a pose of device 520) based on image data 504 captured by camera 502 of device 520. Pose determiner 506 may determine pose data 508 using a computational-geometry technique, for example, SLAM. In some aspects, pose determiner 506 may additionally determine pose data 508 based on IMU data 514 from IMU 512 of device 520.

Based on pose data 508, pose/orientation determiner 510 may determine that a pose constraint is satisfied. For instances, pose/orientation determiner 510 may determine a camera translation and compare the camera translation with an expected range of motion of a neck of the user to decide whether neck constraints are satisfied. Additionally or alternatively, pose/orientation determiner 510 may determine whether:

$${( {R}_{n g} {V}_{g c} )}^{T} ( {T}_{n g} + {R}_{n g} {T}_{g c} ) + {( {T}_{n g} + {R}_{n g} {T}_{g c} )}^{T} ( {R}_{n g} {V}_{g c} ) = 0$$

where R_{ng} represents a rotation (e.g., a rotation matrix) between a reference coordinate system (“g”) and a coordinate system of a neck (“n”) of a user; V_{gc} represents a velocity of a coordinate system of the HMD (“c”) relative to the reference coordinate system (“g”); T_{ng} represents a translation (e.g., translation matrix) between the reference coordinate system (“g”) and the coordinate system of the neck of the user (“n”); and T_{gc} represents a translation between the coordinate system of the HMD (“c”) and the reference coordinate system (“g”).

As another example of determining whether the pose constraint is satisfied, pose/orientation determiner 510 may determine whether the motion of device 520 is around the neck. If the motion is around the neck, translation components of the pose of device 520 will lie on sphere that is centered on the neck. To determine whether the motion of device 520 is around the neck pose/orientation determiner 510 may take the most-recent few seconds (e.g., 10-20 seconds) of pose data 508 determined by pose determiner 506. Pose/orientation determiner 510 may fit the translation estimates to a sphere centered on the neck of the user. Further, pose/orientation determiner 510 may determine whether the residuals from the sphere fit are within a threshold. The residuals being within the threshold indicates that the positions/translations lie on sphere. Pose/orientation determiner 510 may check if the radius of the sphere fit is within the range of neck to display. The residuals being within the threshold, and radius being within the range means that motion is around the neck.

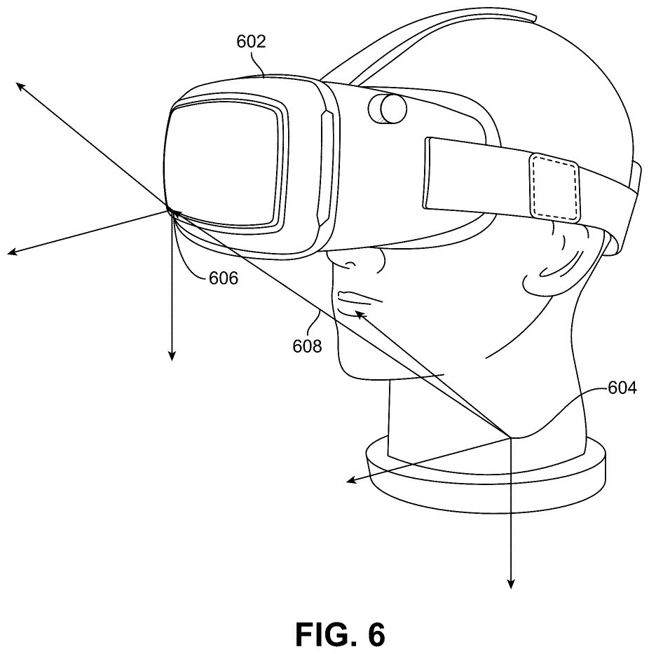

For example, FIG. 6 includes an illustration of an HMD 602 and two relevant reference coordinate systems, according to various aspects of the present disclosure. HMD 602 may be an example of device 520 of FIG. 5.

As an example, FIG. 6 includes a representation of a neck coordinate system 604 which may be based on a point defined based on a point in a neck of a user. Neck coordinate system 604 may be defined as a point around which HMD 602 rotates as a user moves their head without moving their body. Neck coordinate system 604 may be stationary.

Additionally FIG. 6 includes a representation of a reference coordinate system 606 which may be a stationary coordinate system defined as a stationary frame of reference. Reference coordinate system 606 may be defined with an origin at any point. In some aspects, the origin of reference coordinate system 606 may be defined at a point that a camera of HMD 602 may arrive at (e.g., when a user of HMD 602 looks straight ahead with their head level).

Additionally, FIG. 6 includes a representation of a translation 608 between reference coordinate system 606 and neck coordinate system 604. Translation 608 may be an example of T_{ng}. There is a rotation matrix (not illustrated in FIG. 6) between the axes of reference coordinate system 606 and the axes of neck coordinate system 604. The rotation matrix is an example of R_{ng}.

Returning to FIG. 5, based on determining that the pose constraint is satisfied, pose/orientation determiner 510 may switch from using pose determiner 506 to determine pose data 508 to using orientation determiner 516 to determine orientation data 518. For example, pose/orientation determiner 510 may disable or bypass pose determiner 506. Additionally, pose/orientation determiner 510 may enable or continue using orientation determiner 516 to determine orientation data 518.

For example, system 500 may determine a 3DoF orientation of a device 520 (e.g., an HMD) according to a 3DoF orientation-determination mode of operation. For example, pose/orientation determiner 510 may obtain IMU data 514 (e.g., from IMU 512 of device 520). System 500 may use an orientation determiner 516 to determine orientation data 518 (e.g., indicative of an orientation of device 520) based on IMU data 514 measured by IMU 512 of device 520. In some aspects, orientation determiner 516 may determine orientation data 518 based on IMU data 514 and image data 504. For example, in some aspects, orientation determiner 516 may obtain image data 504 (e.g., at a low frame rate) and determine orientation data 518 based, at least in part, on image data 504.

System 500 may conserve computational resources (such as computational time and power) by using orientation determiner 516 to determine orientation data 518 rather than using pose determiner 506 to determine pose data 508.

In some aspects, the systems and techniques (e.g., pose/orientation determiner 510) may determine to switch from the orientation-determination mode of operation (e.g., using orientation determiner 516 and bypassing or disabling pose determiner 506) to the 6DoF pose-determination mode of operation e.g., using pose determiner 506) based on contextual information. For example, pose/orientation determiner 510 may determine, based on IMU data 514, that a user of device 520 is walking.

Additionally or alternatively, device 520 may perform additional operations associated with applications running on device 520. System 500 may determine to contextual information based on the additional applications. For example, device 520 may run a calendar application, or receive data from a calendar application. System 500 may determine contextual information based on data from the calendar application. For instances, system 500 may determine whether a user is likely moving or stationary based on calendar events.

As another example, device 520 may run a geolocation application or receive data from a geolocation service. System 500 may determine contextual data based on geolocation data from the geolocation application or service. For instance, system 500 may determine whether the user is moving based on geolocation data. As yet another example, system 500 may determine contextual information based on which applications that are running at device 520. For instance, if device 520 is running a video-entertainment application, or a video-gaming application system 500 may determine that the user is stationary.

If system 500 determines that the user is not stationary, pose/orientation determiner 510 may determine to from the orientation-determination mode of operation to the 6DoF pose-determination mode of operation.

Additionally or alternatively, to properly anchor virtual content, in some aspects, pose/orientation determiner 510 may estimate pose data 508 (e.g., including a pose of device 520) based on the pose constraint and IMU data 514. For example, if rendered virtual content are anchored to points in a scene near a user, not considering the translation may result in a poor user experience. For example, the rendered virtual content may move along with the user's head as the user turns their head. Handling translation via neck constraints, according to various aspects of the present disclosure, can result in better user experience.

In general, pose/orientation determiner 510 may determine to use the orientation-determination mode of operation (e.g., enabling orientation determiner 516), instead of the 6DoF pose-determination mode of operation (e.g., disabling or bypassing pose determiner 506), in situations in which the neck of the user is stationary. As such, the pose/orientation determiner 510 may use the orientation-determination mode of operation (e.g., using orientation determiner 516) in situations in which it can be assumed that the coordinate system of the neck is stationary. As such the coordinate system of the neck (e.g., neck coordinate system 604) may be fixed relative to the reference coordinate system (e.g., reference coordinate system 606). Therefore, R_{gn} (a rotation between the coordinate system of the neck and the reference coordinate system) and T_{gn} (a translation between the coordinate system of the neck and the reference coordinate system) may be fixed.

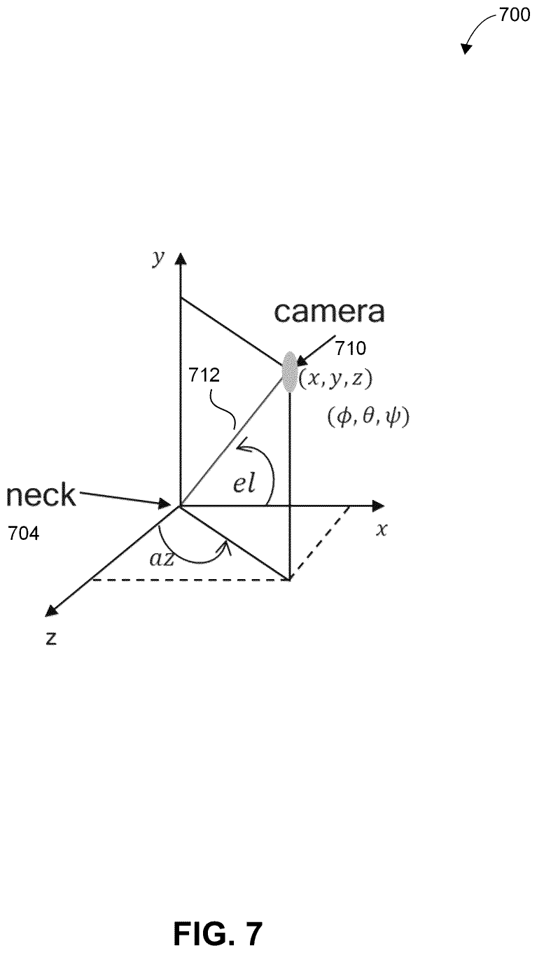

FIG. 7 includes an illustration of two relevant reference coordinate systems, according to various aspects of the present disclosure. As an example, FIG. 7 includes a representation of a neck coordinate system 704 which may be based on a point defined based on a point in a neck of a user. Neck coordinate system 704 may be defined as a point around which an HMD (e.g., device 520 or HMD 602) rotates as a user moves their head without moving their body. Neck coordinate system 704 may be stationary.

Additionally FIG. 7 includes a representation of a camera coordinate system 710. Camera coordinate system 710 may move with the HMD (e.g., device 520 or HMD 602). Camera coordinate system 710 may define a position and orientation of the HMD.

Camera coordinate system 710 may may move with relation to neck coordinate system 704. Neck coordinate system 704 and camera coordinate system 710 may be defined such that camera coordinate system 710 revolves around neck coordinate system 704. For example, the distance between camera coordinate system 710 and neck coordinate system 704 may remain constant as a user wearing the HMD moves their head. Based on such a definition, the position of the HMD (relative to the position of the neck) may be determined based on an orientation of the HMD and the constant distance between the neck and the HMD. For example, the position of camera coordinate system 710 may be determined based on the orientation of the camera coordinate system 710 and the assumption that the camera coordinate system 710 rotates around the neck coordinate system 704. For example, the position of the HMD may be determined based on a rotation between the coordinate system of the HMD and the coordinate system of the neck, a translation between the reference coordinate system and the coordinate system of the neck of the user, and a translation between the coordinate system of the HMD and the reference coordinate system.

For instance, the rotation (denoted as R_{nc}) between the coordinate system of the HMD and the coordinate system of the neck can be based on the following equation:

$${R}_{n c} = {R}_{g n}^{T} {R}_{g c} = {{{[ ϕ ]}_{x} [ θ ]}_{y} [ ψ ]}_{z}$$

where R_{gn} represents a rotation between the coordinate system of the neck and the reference coordinate system; R_{gc} represents a rotation between the coordinate system of the HMD and the reference coordinate system; [φ]ₓ represents the roll of the HMD rotated in an x dimension of the coordinate system of the camera; [θ]_{y} represents the pitch of the HMD rotated in a y dimension of the coordinate system of the camera; and [ψ]_{z} represents the yaw of the HMD rotated in a z dimension of the coordinate system of the camera. For example:

$${[ ϕ ]}_{x} = [ \begin{matrix}1 & 0 & 0 \\ 0 & cos ( ϕ ) & - sin ( ϕ ) \\ 0 & sin ( ϕ ) & cos ( ϕ )\end{matrix} ]$$

$${[ ϕ ]}_{y} = [ \begin{matrix}cos ( θ ) & 0 & sin ( θ ) \\ 0 & 1 & 0 \\ - sin ( θ ) & 0 & cos ( θ )\end{matrix} ]$$

$$and$$

$${[ ψ ]}_{z} = [ \begin{matrix}cos ( ψ ) & - sin ( ψ ) & 0 \\ sin ( ψ ) & cos ( ψ ) & 0 \\ 0 & 0 & 1\end{matrix} ]$$

The translation (denoted as T_{nc}) between the reference coordinate system and the coordinate system of the neck of the user can be determined based on the following equation:

$${T}_{nc} = ‖ {T}_{nc} ‖ [ \begin{matrix}sin ( el ) cos ( a z ) \\ sin ( el ) sin ( a z ) \\ cos ( el )\end{matrix} ]$$

where el represents the elevation angle; and az represents the azimuth angle, for example, as shown in FIG. 7:

The translation (denoted as T_{gc}) between the coordinate system of the HMD and the reference coordinate system can be determined based on the following equation:

$${T}_{g c} = {R}_{g n} ( {T}_{n c} - {T}_{n g} ) = ( {R}_{g n} {T}_{n c} - {R}_{g n} {T}_{n g} )$$

where R_{gn} represents a rotation between the coordinate system of the neck and the reference coordinate system; T_{nc} represents a translation between the coordinate system of the HMD and the coordinate system of the neck; and T_{ng} represents a translation between the reference coordinate system and the coordinate system of the neck of the user.

As another example of estimating the position of the HMD based on the orientation of the HMD, a neck constraint can be used with a camera position as a constraint update in an extended Kalman filter (EKF) or as an additional measurement in an optimizer. The neck constraint may be expressed as

$${T}_{g n} = {R}_{g c} {T}_{c n} + {T}_{g c} = const$$

where T_{gn} represents a translation between the coordinate system of the neck of the user and the reference coordinate system; R_{gc} represents a rotation between the coordinate system of the HMD and the reference coordinate system; Tcn represents a translation between the coordinate system of the neck of the user and the coordinate system of the HMD; T_{gc} represents a translation between the coordinate system of the HMD and the reference coordinate system; and const represents a constant.

As stated previously, R_{gn} (a rotation between the coordinate system of the neck and the reference coordinate system) and T_{gn} (a translation between the coordinate system of the neck and the reference coordinate system) may be fixed. However, to use R_{gn} and T_{gn}, the systems and techniques may obtain R_{gn} and T_{gn}. The systems and techniques may determine R_{gn} and T_{gn} in one of the following example processes.

According to a first example process for determining R_{gn} and T_{gn}, in a feature-rich environment, an optimizer/estimator may solve for following equations:

$${T}_{n c}^{T} {T}_{n c} = constant$$

$$δ ( {( {T}_{n g} + {R}_{n g} {T}_{g c} )}^{T} ( {T}_{n g} + {R}_{n g} {T}_{g c} ) ) = 0$$

$${( {R}_{n g} {V}_{g c} )}^{T} ( {T}_{n g} + {R}_{n g} {T}_{g c} ) + {( {T}_{n g} + {R}_{n g} {T}_{g c} )}^{T} ( {R}_{n g} {V}_{g c} ) = 0$$

where T_{nc} represents a translation between the coordinate system of the HMD and the coordinate system of the neck of the user; T_{ng} represents a translation between the reference coordinate system and the coordinate system of the neck of the user; R_{ng} represents a rotation between the reference coordinate system and the coordinate system of the neck; T_{gc} represents a translation between the coordinate system of the HMD and the reference coordinate system; and V_{gc} represents a velocity of the coordinate system of the HMD relative to the reference coordinate system.

R_{ng} and T_{ng} are unknowns to be estimated by the optimizer. Various forms of orientation representation can be used to obtain R_{ng}, for example, rodrigus, euler, direction cosine matrix (DCM), quaternions.

According to a second example process, R_{gn} and T_{gn} may be determined through a calibration process involving causing a user to look at a predefined target using an XR device. A rotation (denoted as R_{nc}) between the coordinate system of the HMD and the coordinate system of the neck can be determined based on the following equation:

$${R}_{n c} = {R}_{n g} {R}_{g c}$$

where R_{ng} represents a rotation between the reference coordinate system and the coordinate system of the neck and R_{gc} represents a rotation between the coordinate system of the HMD and the reference coordinate system.

A translation (denoted as T_{nc}) between the coordinate system of the HMD and the coordinate system of the neck can be determined based on the following equation:

$${T}_{n c} = {T}_{n g} + {R}_{n g} {T}_{g c}$$

where T_{ng} represents a translation between the reference coordinate system and the coordinate system of the neck of the user; where R_{ng} represents a rotation between the reference coordinate system and the coordinate system of the neck; and where T_{gc} represents a translation between the coordinate system of the HMD and the reference coordinate system.

According to the second example process, T_{gc} and R_{gc} may be estimated by a pose-determination technique. R_{ng} can be assumed to be identity as the coordinate system of the neck and the reference coordinate system may be aligned.

Because the neck remains stationary, the translation T_{nc} between the coordinate system of the HMD and the coordinate system of the neck can be constant, which can be represented using the following equation:

$$‖ {T}_{n c} ‖ = const$$

The above equation can also be represented as follows:

$${( {T}_{n g} + {T}_{g c} )}^{T} ( {T}_{n g} + {T}_{g c} ) = const$$

where T_{ng} represents a translation between the reference coordinate system and the coordinate system of the neck of the user and T_{gc} represents a translation between the coordinate system of the HMD and the reference coordinate system.

Taking the following derivative:

$${( {V}_{g c} )}^{T} ( {T}_{n g} + {T}_{g c} ) + {( {T}_{n g} + {T}_{g c} )}^{T} ( {V}_{g c} ) = 0$$

$${( {V}_{g c} )}^{T} {T}_{n g} = - {( {V}_{g c} )}^{T} {T}_{g c}$$

a pseudo inverse can be determined to compute T_{ng}, where V_{gc} represents a velocity of the coordinate system of the HMD relative to the reference coordinate system. V_{gc} can be determined based on the pose-determination technique. As noted previously, the term T_{ng} represents a translation between the reference coordinate system and the coordinate system of the neck of the user and the term T_{gc} represents a translation between the coordinate system of the HMD and the reference coordinate system.

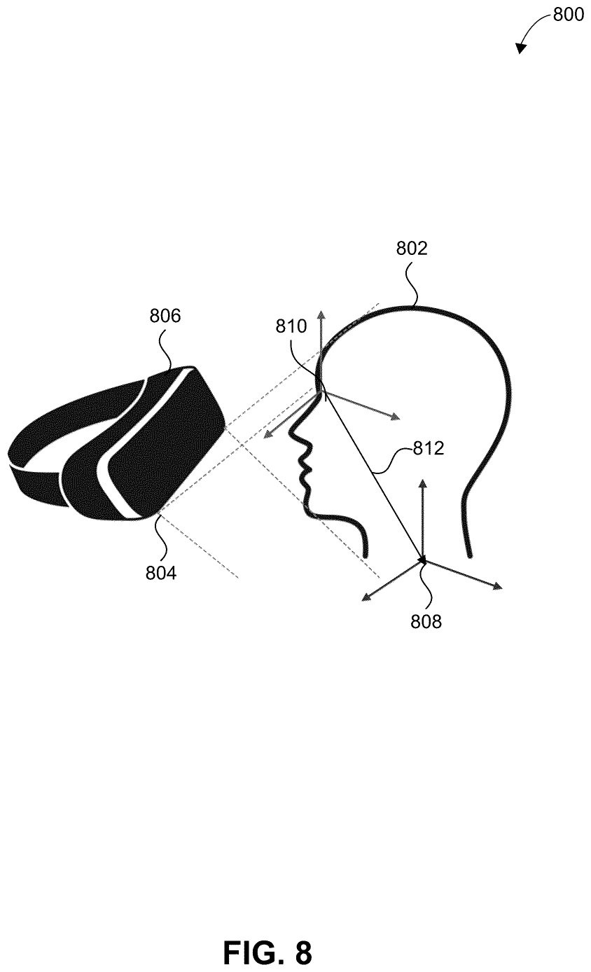

FIG. 8 is an illustration representing a user 802 using an HMD 806 to scan their face to determine R_{gn} and T_{gn}, according to various aspects of the present disclosure. According to the third example process, a user 802 may scan their face and neck with one or more camera(s) 404 (e.g., of an HMD 806). Camera(s) 804 may capture image data and an IMU of HMD 806 may capture IMU data while user 802 scans their face and neck. HMD 806 (or another computing device, such as a server) may perform a 3D reconstruction to determine a 3D model (e.g., point cloud, 3D mesh, etc.) of the face and neck of user 802. The HMD (or the other computing device) may estimate a nose-bridge to neck transformation based on the 3D model to determine a display to neck transformation (e.g., a transformation 812 between nose-bridge coordinate system 810 and neck coordinate system 808).

In some aspects, HMD 806 may store the nose-bridge to neck transformation associated with the user (e.g., based on a user profile) and apply the nose-bridge to neck transformation when the user subsequently uses HMD 806.

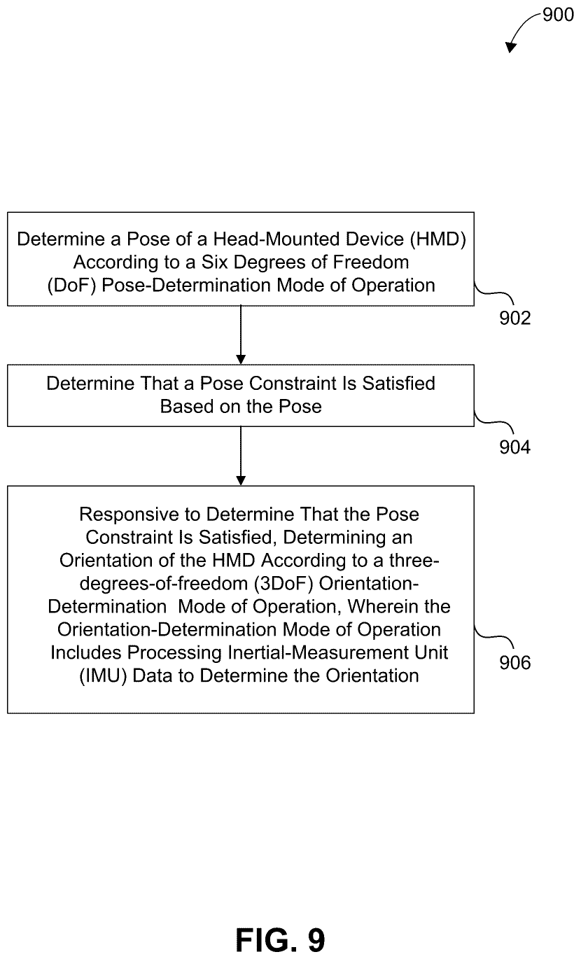

FIG. 9 is a flow diagram illustrating an example process 900 for determining orientation information, in accordance with aspects of the present disclosure. One or more operations of process 900 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 900. The one or more operations of process 900 may be implemented as software components that are executed and run on one or more processors.

At block 902, a computing device (or one or more components thereof) may determine a pose of a head-mounted device (HMD) according to a six-degrees-of-freedom (6DoF) pose-determination mode of operation. For example, pose determiner 506 may determine pose data 508 (e.g., a pose of device 520) according to a 6DoF pose-determination mode of operation (e.g., based on image data 504).

In some aspects, the pose of the HMD may be, or may include, a position of the HMD and a corresponding orientation of the HMD. The 6DoF pose-determination mode of operation may include processing image data captured at the HMD to determine the pose of the HMD. For example, pose determiner 506 may determine pose data 508 based on image data 504. Pose data 508 may include a position and an orientation of device 520.

At block 904, the computing device (or one or more components thereof) may determine that a pose constraint is satisfied based on the determined pose. For example, orientation determiner 510 may determine that a pose constraint is satisfied based on pose data 508.

In some aspects, the computing device (or one or more components thereof) may determine a translation of the device relative to a reference coordinate system based on the determined pose; and comparing the translation of the device to an expected range of motion of a neck of a user. The pose constraint may be determined to be satisfied based on the comparison. For example, orientation determiner 510 may determine whether device 520 remains within an expected range of motion of a neck of a user. For instance, orientation determiner 510 may determine whether device 520 lies on a sphere that is centered on the neck.

In some aspects, the computing device (or one or more components thereof) may determine a first translation matrix to associate a reference coordinate system and a coordinate system of a neck of a user; determine a second translation matrix to associate a coordinate system of the HMD and the reference coordinate system; and determine that the pose constraint is satisfied based on the first translation matrix and the second translation matrix. For example, orientation determiner 510 may determine T_{ng} (which represents a translation (e.g., translation matrix) between the reference coordinate system (“g”) and the coordinate system of the neck of the user (“n”)) and Tₑ (which represents a translation between the coordinate system of the HMD (“c”) and the reference coordinate system (“g”)) Further pose/orientation determiner 510 may determine whether:

$${( {R}_{n g} {V}_{g c} )}^{T} ( {T}_{n g} + {R}_{n g} {T}_{g c} ) + {( {T}_{n g} + {R}_{n g} {T}_{g c} )}^{T} ( {R}_{n g} {V}_{g c} ) = 0$$

At block 906, the computing device (or one or more components thereof) may responsive to determining that the pose constraint is satisfied, determine an orientation of the HMD according to a three-degrees-of-freedom (3DoF) orientation-determination mode of operation, wherein the 3DoF orientation-determination mode of operation includes processing inertial-measurement unit (IMU) data to determine the orientation. For example, orientation determiner 516 may determine orientation data 518 (e.g., an orientation of device 520) according to a 3DoF orientation-determination mode of operation. Orientation determiner 516 may determine orientation data 518 based on IMU data 514.

In some aspects, the pose of the HMD may be a first pose of the HMD. The computing device (or one or more components thereof) may estimate a second pose of the HMD based on the IMU data and the pose constraint. For example, orientation determiner 510 may estimate a position of orientation determiner 510 based on IMU data 514 and the pose constraint. For example, orientation determiner 510 may assume that device 520 may move around a sphere centered on the neck and estimate a position of device 520 on the sphere based on an orientation of device 520.

In some aspects, wherein the pose of the HMD may be a first pose of the HMD. The computing device (or one or more components thereof) may determine that a contextual condition is satisfied based on contextual information; and responsive to determining that the contextual condition is satisfied, determining a second pose of the HMD according to the 6DoF pose-determination mode of operation. For example, orientation determiner 510 may determine that a contextual condition is satisfied based on contextual information. Based on the contextual condition being satisfied, orientation determiner 510 may determine to use pose determiner 506 to determine pose data 508 based on image data 504 according to a 6DoF pose-determination mode of operation.

In some aspects, the contextual information relates to movement of a user of the HMD relative to an environment of the user. For example, the contextual information may relate to a user of device 520 moving within their environment.

In some aspects, the contextual information relates to at least one of: application data; calendar information; or geolocation data. For example, orientation determiner 510 may determine that the user of device 520 is moving based on application data, calendar information, and/or geolocation data.

In some aspects, the computing device (or one or more components thereof) may adjust one or more rendering parameters used to render data for display at the HMD responsive to determining that the pose constraint is satisfied. For example, based on orientation determiner 510 determining that the pose constraint is satisfied, device 520 may adjust one or more parameters used to render data for display by device 520.

In some aspects, the computing device (or one or more components thereof) may render data for display at the HMD based on the orientation of the HMD. For example, device 520 may render data for display by device 520 based on orientation data 518.

In some examples, as noted previously, the methods described herein (e.g., process 900 of FIG. 9, and/or other methods described herein) can be performed, in whole or in part, by a computing device or apparatus. In one example, one or more of the methods can be performed by XR device 104 of FIG. 1, display device 204, processing device 206, and/or companion device 208 of FIG. 2, XR system 300 of FIG. 3, SLAM system 400 of FIG. 4, system 500 of FIG. 5, pose/orientation determiner 510 of FIG. 5, HMD 602 of FIG. 6, HMD 806 of FIG. 8, or by another system or device. In another example, one or more of the methods (e.g., process 900, and/or other methods described herein) can be performed, in whole or in part, by the computing-device architecture 1000 shown in FIG. 10. For instance, a computing device with the computing-device architecture 1000 shown in FIG. 10 can include, or be included in, the components of the XR device 104, display device 204, processing device 206, companion device 208, XR system 300, SLAM system 400, system 500, pose/orientation determiner 510, HMD 602, and/or HMD 806 and can implement the operations of process 900, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 900, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 900, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 10 illustrates an example computing-device architecture 1000 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1000 may include, implement, or be included in any or all of XR device 104 of FIG. 1, display device 204, processing device 206, and/or companion device 208 of FIG. 2, XR system 300 of FIG. 3, SLAM system 400 of FIG. 4, system 500 of FIG. 5, pose/orientation determiner 510 of FIG. 5, HMD 602 of FIG. 6, HMD 806 of FIG. 8 and/or other devices, modules, or systems described herein. Additionally or alternatively, computing-device architecture 1000 may be configured to perform process 900, and/or other process described herein.

The components of computing-device architecture 1000 are shown in electrical communication with each other using connection 1012, such as a bus. The example computing-device architecture 1000 includes a processing unit (CPU or processor) 1002 and computing device connection 1012 that couples various computing device components including computing device memory 1010, such as read only memory (ROM) 1008 and random-access memory (RAM) 1006, to processor 1002.

Computing-device architecture 1000 can include a cache of high-speed memory connected directly with, in close proximity to, or integrated as part of processor 1002. Computing-device architecture 1000 can copy data from memory 1010 and/or the storage device 1014 to cache 1004 for quick access by processor 1002. In this way, the cache can provide a performance boost that avoids processor 1002 delays while waiting for data. These and other modules can control or be configured to control processor 1002 to perform various actions. Other computing device memory 1010 may be available for use as well. Memory 1010 can include multiple different types of memory with different performance characteristics. Processor 1002 can include any general-purpose processor and a hardware or software service, such as service 1 1016, service 2 1018, and service 3 1020 stored in storage device 1014, configured to control processor 1002 as well as a special-purpose processor where software instructions are incorporated into the processor design. Processor 1002 may be a self-contained system, containing multiple cores or processors, a bus, memory controller, cache, etc. A multi-core processor may be symmetric or asymmetric.

To enable user interaction with the computing-device architecture 1000, input device 1022 can represent any number of input mechanisms, such as a microphone for speech, a touch-sensitive screen for gesture or graphical input, keyboard, mouse, motion input, speech and so forth. Output device 1024 can also be one or more of a number of output mechanisms known to those of skill in the art, such as a display, projector, television, speaker device, etc. In some instances, multimodal computing devices can enable a user to provide multiple types of input to communicate with computing-device architecture 1000. Communication interface 1026 can generally govern and manage the user input and computing device output. There is no restriction on operating on any particular hardware arrangement and therefore the basic features here may easily be substituted for improved hardware or firmware arrangements as they are developed.

Storage device 1014 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1006, read only memory (ROM) 1008, and hybrids thereof. Storage device 1014 can include services 1016, 1018, and 1020 for controlling processor 1002. Other hardware or software modules are contemplated. Storage device 1014 can be connected to the computing device connection 1012. In one aspect, a hardware module that performs a particular function can include the software component stored in a computer-readable medium in connection with the necessary hardware components, such as processor 1002, connection 1012, output device 1024, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“<”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for determining orientation information, the apparatus comprising: at least one memory; and at least one processor coupled to the at least one memory and configured to: determine a pose of a head-mounted device (HMD) according to a six-degrees-of-freedom (6DoF) pose-determination mode of operation; determine that a pose constraint is satisfied based on the determined pose; and responsive to determining that the pose constraint is satisfied, determine an orientation of the HMD according to a three-degrees-of-freedom (3DoF) orientation-determination mode of operation, wherein the 3DoF orientation-determination mode of operation includes processing inertial-measurement unit (IMU) data to determine the orientation.

Aspect 2. The apparatus of aspect 1, wherein the at least one processor is configured to: determine a translation of the device relative to a reference coordinate system based on the determined pose; and compare the translation of the device to an expected range of motion of a neck of a user; wherein the pose constraint is determined to be satisfied based on the comparison.

Aspect 3. The apparatus of any one of aspects 1 or 2, wherein the at least one processor is configured to: determine a first translation matrix to associate a reference coordinate system and a coordinate system of a neck of a user; determine a second translation matrix to associate a coordinate system of the HMD and the reference coordinate system; and determine that the pose constraint is satisfied based on the first translation matrix and the second translation matrix.

Aspect 4. The apparatus of any one of aspects 1 to 3, wherein the pose of the HMD comprises a first pose of the HMD, wherein the at least one processor is configured to estimate a second pose of the HMD based on the IMU data and the pose constraint.

Aspect 5. The apparatus of any one of aspects 1 to 4, wherein the pose of the HMD comprises a first pose of the HMD, wherein the at least one processor is configured to: determine that a contextual condition is satisfied based on contextual information; and responsive to determining that the contextual condition is satisfied, determine a second pose of the HMD according to the 6DoF pose-determination mode of operation.

Aspect 6. The apparatus of aspect 5, wherein the contextual condition relates to movement of a user of the HMD relative to an environment of the user.

Aspect 7. The apparatus of any one of aspects 5 or 6, wherein the contextual information relates to at least one of: application data; calendar information; or geolocation data.

Aspect 8. The apparatus of any one of aspects 1 to 7, wherein: the pose of the HMD comprises a position of the HMD and a corresponding orientation of the HMD; and the 6DoF pose-determination mode of operation includes processing image data captured at the HMD to determine the pose of the HMD.

Aspect 9. The apparatus of any one of aspects 1 to 8, wherein the at least one processor is configured to adjust one or more rendering parameters used to render data for display at the HMD responsive to determining that the pose constraint is satisfied.

Aspect 10. The apparatus of any one of aspects 1 to 9, wherein the at least one processor is configured to render data for display at the HMD based on the orientation of the HMD.

Aspect 11. A method for determining orientation information, the method comprising: determining a pose of a head-mounted device (HMD) according to a six-degrees-of-freedom (6DoF) pose-determination mode of operation; determining that a pose constraint is satisfied based on the determined pose; and responsive to determining that the pose constraint is satisfied, determining an orientation of the HMD according to a three-degrees-of-freedom (3DoF) orientation-determination mode of operation, wherein the 3DoF orientation-determination mode of operation includes processing inertial-measurement unit (IMU) data to determine the orientation.

Aspect 12. The method of aspect 11, further comprising: determining a translation of the device relative to a reference coordinate system based on the determined pose; and comparing the translation of the device to an expected range of motion of a neck of a user; wherein the pose constraint is determined to be satisfied based on the comparison.

Aspect 13. The method of any one of aspects 11 or 12, further comprising: determining a first translation matrix to associate a reference coordinate system and a coordinate system of a neck of a user; determining a second translation matrix to associate a coordinate system of the HMD and the reference coordinate system; and determining that the pose constraint is satisfied based on the first translation matrix and the second translation matrix.

Aspect 14. The method of any one of aspects 11 to 13, wherein the pose of the HMD comprises a first pose of the HMD, the method further comprising estimating a second pose of the HMD based on the IMU data and the pose constraint.

Aspect 15. The method of any one of aspects 11 to 14, wherein the pose of the HMD comprises a first pose of the HMD, the method further comprising: determining that a contextual condition is satisfied based on contextual information; and responsive to determining that the contextual condition is satisfied, determining a second pose of the HMD according to the 6DoF pose-determination mode of operation.

Aspect 16. The method of aspect 15, wherein the contextual condition relates to movement of a user of the HMD relative to an environment of the user.

Aspect 17. The method of any one of aspects 15 or 16, wherein the contextual information relates to at least one of: application data; calendar information; or geolocation data.

Aspect 18. The method of any one of aspects 11 to 17, wherein: the pose of the HMD comprises a position of the HMD and a corresponding orientation of the HMD; and the 6DoF pose-determination mode of operation includes processing image data captured at the HMD to determine the pose of the HMD.

Aspect 19. The method of any one of aspects 11 to 18, further comprising adjusting one or more rendering parameters used to render data for display at the HMD responsive to determining that the pose constraint is satisfied.

Aspect 20. The method of any one of aspects 11 to 19, further comprising rendering data for display at the HMD based on the orientation of the HMD.

Aspect 21. A non-transitory computer-readable storage medium having stored thereon instructions that, when executed by at least one processor, cause the at least one processor to perform operations according to any of aspects 11 to 20.

Aspect 22. An apparatus for providing virtual content for display, the apparatus comprising one or more means for perform operations according to any of aspects 11 to 20.

1. An apparatus for determining orientation information, the apparatus comprising:
at least one memory; and
at least one processor coupled to the at least one memory and configured to:
determine a pose of a head-mounted device (HMD) according to a six-degrees-of-freedom (6DoF) pose-determination mode of operation, wherein the pose of the HMD comprises a position of the HMD and an orientation of the HMD and wherein the 6DoF pose-determination mode of operation includes processing image data captured at the HMD to determine the pose of the HMD;
determine that a pose constraint is satisfied based on the determined pose;
responsive to determining that the pose constraint is satisfied, switch between the 6DoF pose-determination mode of operation and a three-degrees-of-freedom (3DoF) orientation-determination mode of operation; and
determine the orientation of the HMD according to the 3DoF orientation-determination mode of operation, wherein the 3DoF orientation-determination mode of operation includes processing inertial-measurement unit (IMU) data to determine the orientation.

2. The apparatus of claim 1, wherein the at least one processor is configured to:
determine a translation of the HMD relative to a reference coordinate system based on the determined pose; and
compare the translation of the HMD to an expected range of motion of a neck of a user;
wherein the pose constraint is determined to be satisfied based on the comparison.

3. The apparatus of claim 1, wherein the at least one processor is configured to:
determine a first translation matrix to associate a reference coordinate system and a coordinate system of a neck of a user;
determine a second translation matrix to associate a coordinate system of the HMD and the reference coordinate system; and
determine that the pose constraint is satisfied based on the first translation matrix and the second translation matrix.

4. The apparatus of claim 1, wherein the pose of the HMD comprises a first pose of the HMD, wherein the at least one processor is configured to estimate a second pose of the HMD based on the IMU data and the pose constraint.

5. The apparatus of claim 1, wherein the pose of the HMD comprises a first pose of the HMD, wherein the at least one processor is configured to:
determine that a contextual condition is satisfied based on contextual information; and
responsive to determining that the contextual condition is satisfied, determine a second pose of the HMD according to the 6DoF pose-determination mode of operation.

6. The apparatus of claim 5, wherein the contextual condition relates to movement of a user of the HMD relative to an environment of the user.

7. The apparatus of claim 5, wherein the contextual information relates to at least one of:
application data;
calendar information; or
geolocation data.

8. (canceled)

9. The apparatus of claim 1, wherein the at least one processor is configured to adjust one or more rendering parameters used to render data for display at the HMD responsive to determining that the pose constraint is satisfied.

10. The apparatus of claim 1, wherein the at least one processor is configured to render data for display at the HMD based on the orientation of the HMD.

11. A method for determining orientation information, the method comprising:
determining a pose of a head-mounted device (HMD) according to a six-degrees-of-freedom (6DoF) pose-determination mode of operation, wherein the pose of the HMD comprises a position of the HMD and an orientation of the HMD and wherein the 6DoF pose-determination mode of operation includes processing image data captured at the HMD to determine the pose of the HMD;
determining that a pose constraint is satisfied based on the determined pose;
responsive to determining that the pose constraint is satisfied, switching between the 6DoF pose-determination mode of operation and a three-degrees-of-freedom (3DoF) orientation-determination mode of operation; and
determining the orientation of the HAMID according to the 3DoF orientation-determination mode of operation, wherein the 3DoF orientation-determination mode of operation includes processing inertial-measurement unit (IMU) data to determine the orientation.

12. The method of claim 11, further comprising:
determining a translation of the HMD relative to a reference coordinate system based on the determined pose; and
comparing the translation of the HMD to an expected range of motion of a neck of a user;
wherein the pose constraint is determined to be satisfied based on the comparison.

13. The method of claim 11, further comprising:
determining a first translation matrix to associate a reference coordinate system and a coordinate system of a neck of a user;
determining a second translation matrix to associate a coordinate system of the HMD and the reference coordinate system; and
determining that the pose constraint is satisfied based on the first translation matrix and the second translation matrix.

14. The method of claim 11, wherein the pose of the HMD comprises a first pose of the HMD, the method further comprising estimating a second pose of the HMD based on the IMU data and the pose constraint.

15. The method of claim 11, wherein the pose of the HMD comprises a first pose of the HMD, the method further comprising:
determining that a contextual condition is satisfied based on contextual information; and
responsive to determining that the contextual condition is satisfied, determining a second pose of the HMD according to the 6DoF pose-determination mode of operation.

16. The method of claim 15, wherein the contextual condition relates to movement of a user of the HMD relative to an environment of the user.

17. The method of claim 15, wherein the contextual information relates to at least one of:
application data;
calendar information; or
geolocation data.

18. (canceled)

19. The method of claim 11, further comprising adjusting one or more rendering parameters used to render data for display at the HMD responsive to determining that the pose constraint is satisfied.

20. The method of claim 11, further comprising rendering data for display at the HMD based on the orientation of the HMD.
